(19) United States
(12) Patent Application Publication
(10) Pub. No.: US 2007/0290466 A1
(43) Pub. Date: Dec. 20, 2007

(54) Three wheeled cooler with handle

(76) Inventor: Arthur W. Lenz, Omaha, NE (US)

Correspondence Address: Philip J. Lee, Suite 525, 10050 Regency Circle, Omaha, NE, 68114, US

(21) Appl. No.: 11/454,552

(22) Filed: Jun. 16, 2006

(51) Int. Cl. B62B 1/00

(52) U.S. Cl. 280/47.26

(57) ABSTRACT

A portable cooler with four side walls, a bottom and a top includes two wheels partially recessed into opposite corners of one side wall close to the junction with the cooler bottom, a portion of each wheel extending past the side wall and a third wheel mounted on the side wall between and above the first two wheels and an extendable handle is fastened to the side wall on which the third wheel is mounted. A ledge surrounds a lid which can be raised and lowered for access into the interior of the cooler, the ledge being wide enough that drinks can be rested on the ledge without preventing or impeding the opening and closing of the cooler lid.

### BACKGROUND OF THE INVENTION

A. Field of Invention

The present invention relates generally to insulated coolers and more particularly to a new and improved cooler having at least three wheels, a telescoping handle and an improved top.

B. Description of Related Art

Conventional beverage or food coolers are insulated boxes with a removable or hinged lid and capacity to contain ice or other cooling material as well as the food and/or beverages to be kept cool. A reasonable amount of beverage and ice can have a significant weigh and simple coolers designed to be carried by a pair of side handles can be difficult and unwieldy to transport. Adding wheels to a cooler has been done by fixing wheels at two or four of the bottom corners of the cooler. The placement of wheels on all four corners of a cooler bottom renders the cooler stabile but laterally insecure as it is prone to unintended movement. The configuration of a cooler with two wheels with each wheel on laterally opposing corners is an improvement over the four wheeled design in that the wheels can be set partially into the side of the cooler so that the wheels are off the ground when the cooler bottom is flat on the ground. In this way, inadvertent movement of the cooler is prevented. A variety of such two wheeled coolers have been designed, generally with an extended handle secured to the side of the cooler opposite to the side to which the wheels are attached. Securing the handle on the opposite side of the cooler requires the operator to lift a substantial amount of the weight of the cooler and its contents. Therefore, the handle apparatus must be strong and transporting the cooler requires significant effort. Placing the handle on the same side of the cooler allows the operator to balance the weight of the cooler and its contents on the two wheels, but the cooler is made unstable as a result. U.S. Pat. No. 5,249,438 to Rhaney and Bartlett illustrates a two wheeled cooler that uses a handle secured to the same side as the wheels; however, the Rhaney and Bartlett device appears to be unstable since the load would be balanced on the two wheels and the cooler would be prone to tip over, spilling the contents.

An additional difficulty with conventional coolers results from the custom of construction a lid that covers the entire top of the cooler such that anything placed on top of the cooler must be removed before opening the cooler.

It would therefore be desirable to provide a cooler that can be stable in transport and secure when not in transit and that does not requiring the user to lift a substantial weight when moving the cooler.

### SUMMARY OF THE INVENTION

The method of the present invention comprises a three wheeled cooler with a telescoping handle assembly secured to the same side of the cooler as the wheels are attached. The cooler conventionally is an insulated box comprising four vertical walls, a bottom and an openable top or lid having two wheels placed side by side at or near the junction of one wall and the bottom, such that the axes of the axles of the two corner wheels are collinear. The improvement of the present invention comprises the addition of a telescoping and upwardly extendable handle secured to the wall at which the two wheels are attached and the addition of a third wheel attached to the wall to which the two wheels and handle are attached. The third wheel being placed laterally between and vertically above the two wheels when the cooler rests on its bottom. A user of the invention can extend the handle vertically and, by use of the handle, tilt the cooler to rest or roll while supported by the three wheels. When resting on the three wheels, the cooler is stable and the user is not required to balance or lift the load of the cooler and its contents on the axles of the two corner wheels.

The top surface of the cooler comprises a generally flat lid that may be hinged at one side and a ledge surrounding the lid of a width sufficient to allow users to place items such as drinks on the ledge without hampering the opening of the cooler lid. The ledge is preferably strong enough on all four sides to serve as a handle for lifting the cooler. An additional improvement to the lid is the inclusion of a compartment recessed into the lid surface and having a closeable lid, the compartment being useful for the storage of condiments or other small items not needing the full refrigeration available inside the cooler.

The principle aim of the present invention is to provide a new and improved cooler that meets the foregoing requirements and is convenient to transport.

Other objects and advantages of the invention will become apparent from the Description of the Preferred Embodiments and the Drawings and will be in part pointed out in more detail hereinafter.

The invention consists in the features of construction, combination of elements and arrangement of parts exemplified in the construction hereinafter described and the scope of the invention will be indicated in the appended claims.

### BRIEF DESCRIPTION OF THE DRAWINGS

FIG. 1 is a side view of the cooler of the present invention with handle extended and the cooler tipped back to rest on all wheels.

FIG. 2 is a side view of the cooler in accord with the present invention with handle extended and the cooler resting on the cooler bottom.

FIG. 3 is a top view of the cooler in accord with the present invention.

FIG. 4 is a rear view of the cooler in accord with the present invention with handle extended.

### DESCRIPTION OF THE PREFERRED EMBODIMENT(S)

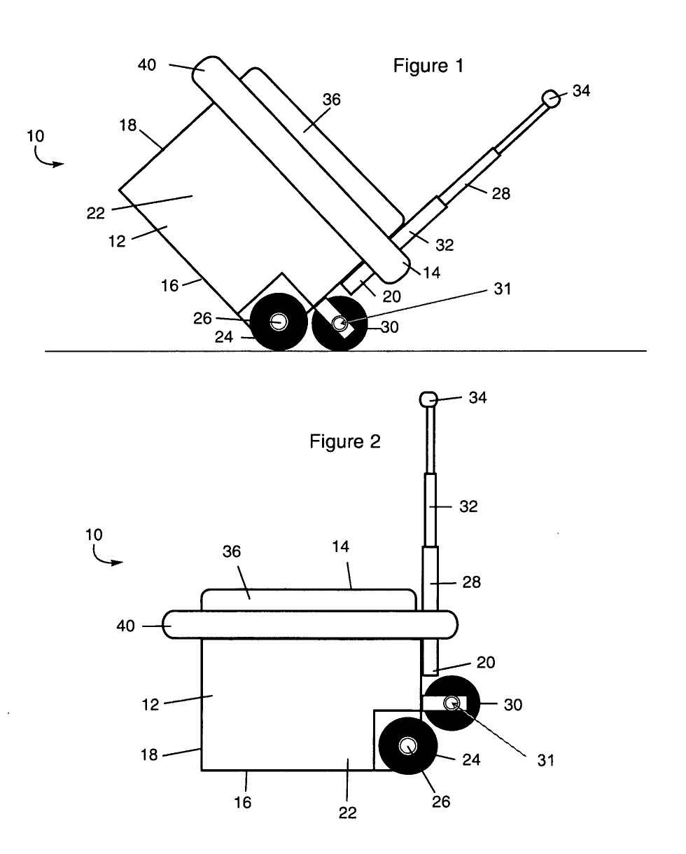

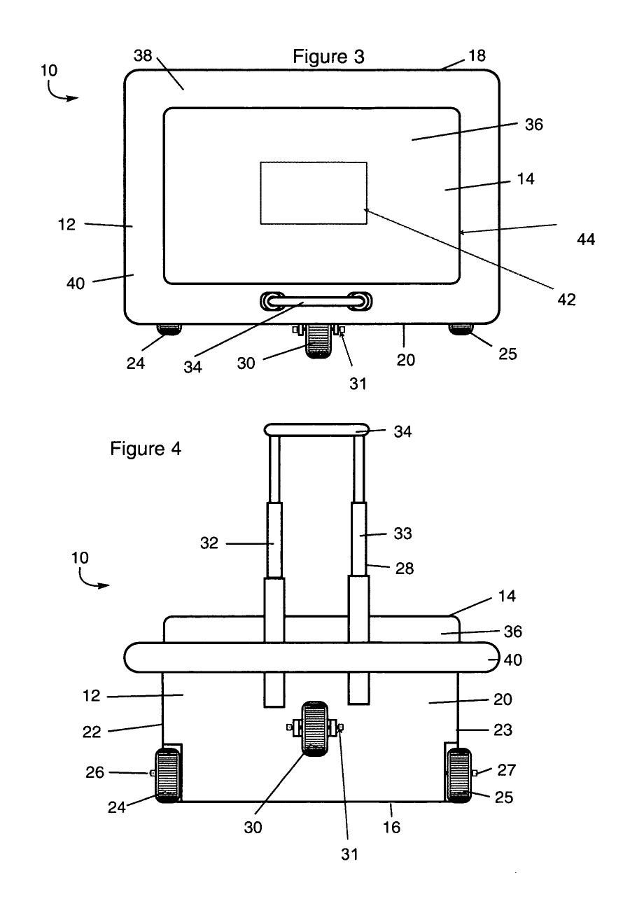

With reference to the Drawings wherein like numerals represent like parts throughout the Figures, a cooler device of the present invention is generally designated by numeral 10 in FIGS. 1-4. Device 10 comprises a generally rectangular box shaped cooler body 12 formed of suitable and conventional insulating material, with a top 14, a generally flat and rectangular bottom 16 generally parallel to top 14, a generally flat and rectangular front 18, a generally flat and rectangular back 20 generally parallel to front 18 and two rectangular and generally parallel side walls 22 and 23. Top 14 and bottom 16 are both connected to and separated by front 18, back 20 and side walls 22 and 23, which are also connected between the front 18 and back 20, thereby forming the walls of cooler body 12 and defining the interior of cooler body 12. A pair of small wheels 24 and 25 are mounted on axles 26 and 27 proximate to the corner junctions of the bottom 16, back 20 and side walls 22 and 23. Corner wheels 24 and 25 are mounted and partially contained within recesses in side walls 22 and 23 such that the wheels 24 and 25 do not extend downward past the cooler bottom 16, but do extend rearward past the back wall 20 of the cooler body 12. The axes of axles 26 and 27 are collinear and it will be anticipated that a single axle could be substituted for axles 26 and 27 without changing the function of corner wheels 24 and 25. A third wheel 30 is mounted on the back wall 20 of cooler 10, in a position laterally spaced between the two side wheels 24 and 25 and vertically separated above the two side wheels 24 and 25. In the illustrated preferred embodiment of device 10, third wheel 30 is mounted in about the center of cooler back wall 20, which placement results in the three wheels 24, 25, and 30 being coplanar on a plane that is about 45 degrees from the plane of the device bottom 16. The cooler device 10 assumes an angle of about 45 degrees from ground, shown in FIG. 1 as line 46, when cooler device 10 is tilted such that it rests with all three wheels on the ground. It will be anticipated that a variety of vertical positions of third wheel 30 can be used with the limitation that increased vertical spacing of wheel 30 above side wheels 24 and 25 may require an increased extension of the mounting bracket supporting third wheel 30 to avoid an undesirable angle of cooler device 10 when tilted to rest on all three wheels. Third wheel 30 may be mounted on a bracket providing a stationary or a swiveling axle and if stationary, the third wheel axle 31 is mounted to be parallel to the axles of corner wheels 24 and 25. A telescoping handle assembly 28 is secured to the back side wall 20 of the cooler body 12 above the position of the third wheel 30 and comprises two telescoping linearly extendable sections 32 and 33, connected by a handle section 34 that connects between the outward ends of the telescoping sections 32 and 33.

The cooler top 14 comprises a generally rectangular opening 44 and a removable or operable lid 36 and a flat ledge 38 surrounding opening 44. Ledge 38 has a rectangular outer edge 40 which is of greater lateral dimensions than the lid 36 and thereby extends laterally beyond lid 36 in width and depth approximately four inches, forming a surface upon which items can be placed without interfering with the opening of lid 36. Recesses may be molded into the top surface of ledge 38 to securely accommodate drinks or other items placed thereon. A recessed compartment 42 with an openable lid 46 is set into the cooler lid 36 and may have an insulated floor or may extend to and vent into the interior of cooler body 12.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention. It is specifically anticipated a variety of materials could be suitable for use in constructing cooler 10 and that a pair of wheels could replace the third wheel 30 without departing from the spirit of this invention. It will be further anticipated that alternative mechanisms for mounting third wheel 30 can be used, such as a folding support.

What is claimed is:

1. A cooler device comprising a generally rectangular body comprising a top surface and an opposing bottom surface connected by a front wall and a back wall and two side walls connected between the top and bottom and between the front and back walls, thereby forming two corner junctions comprised of one side wall, the back wall and the device bottom, with a first wheel mounted at one corner junction and a second wheel mounted at the other corner junction and a third wheel mounted on the back wall of the device.

2. The device of claim 1, wherein the third wheel is mounted laterally between the first and second wheels and vertically separated therefrom and raised above the first and second wheels to be closer to the device top than the first and second wheels.

3. The device of claim 2, further comprising recesses formed at each corner junction of one side wall, the back wall and the device bottom and wherein the first wheel is mounted within one of the corner junction recesses and the second wheel is mounted within the other of the corner junction recesses.

4. The device of claim 2, wherein the first and second wheels are mounted on axles having collinear axes.

5. The device of claim 4, further comprising a telescoping handle assembly secured to and extending from the back wall of the device.

6. The device of claim 5, wherein the device top comprises a generally rectangular and removable or operable lid and a ledge surrounding the lid.

7. The device of claim 6, wherein the device lid comprises a recessed compartment and a lid covering the compartment.
